(19) United States
(12) Patent Application Publication
(10) Pub. No.: US 2026/0301589 A1
(43) Pub. Date: Oct. 1, 2026

(54) AIRCRAFT DIVERSION MANAGEMENT

(71) Applicant: Honeywell International Inc., Charlotte, NC (US)

(72) Inventors: Minni Ambooken, Bangalore (IN); Mahesh Sivaratri, Bangalore (IN); Naresh Bandam, Bangalore (IN); Dhinesh Babu Solankrishnakumar, Bangalore (IN); Santosh Sharma, Jaipur (IN)

(21) Appl. No.: 19/228,577

(22) Filed: Jun. 4, 2025

(30) Foreign Application Priority Data
Mar. 25, 2025 (IN) 202511027691

(51) Int. Cl. G08G 5/55; G08G 5/22

(52) U.S. Cl. CPC G08G 5/55; G08G 5/22; G08G 5/34; G08G 5/38; G01C 21/20; G08G 5/58

(57) ABSTRACT

Certain aspects of the disclosure pertain to managing aircraft diversion. After an aircraft departs from an airport headed to a destination airport, a situation can occur during flight that dictates that the aircraft be diverted to an alternate airport prior to reaching the destination airport. In accordance with one aspect, a request can be made to divert the aircraft. Responsive to the request, a model is invoked that is configured to identify one or more candidate airports from a plurality of airports based on real-time aircraft state data and information regarding the plurality of airports and surrounding context. The one or more candidate airports can be transmitted to an onboard avionics system of the aircraft as a recommendation for alternate airports. Subsequently, an aircraft can be diverted to selected alternate airport.

This application claims the benefit of Indian Provisional Patent Application No. 202511027691, filed Mar. 25, 2025, the entire contents of which are incorporated herein by reference.

### TECHNICAL FIELD

Aspects of the subject disclosure relate to aviation technology, including aircraft diversion.

### BACKGROUND

Aircraft travel begins with submitting a flight plan to air traffic control (ATC). The flight plan typically includes identification of origin and destination airports, a planned route, and an estimated arrival time. After ATC approves the flight plan, the flight plan is loaded into the avionics system of an aircraft, which assists with navigation and flight management.

After clearance is granted for departure, the aircraft takes off from the origin airport and follows the planned route to the destination airport. During the flight, unforeseen situations may arise, such as mechanical issues, adverse weather conditions, or medical emergencies involving passengers or crew members. In such cases, a pilot can contact ATC and request clearance to divert the flight to the nearest airport. After ATC approves the request, the avionics system updates the flight path and adjusts flight parameters to reroute the aircraft to the newly assigned destination.

### SUMMARY

The following summary provides a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description presented later.

Briefly described, various methods, apparatuses, and systems related to improving the management of aircraft diversions are disclosed. During a flight, a request can be made to divert an aircraft given an unforeseen situation such as a medical emergency or equipment failure. Responsive to the request, a model can be invoked that is configured to identify one or more candidate airports from a plurality of airports based on real-time aircraft state data, information regarding the plurality of airports, and surrounding context from multiple data sources. The one or more candidate airports can be transmitted to an onboard avionics system of the aircraft as a recommendation for alternate airports based on a suitability score, which is a numerical representation that quantifies the appropriateness of an alternate airport based on evaluation of multiple factors. Subsequently, an aircraft can be diverted to an alternate selected airport. Such a data-driven approach to aircraft diversion management enhances the safety and efficiency of aircraft diversions.

Certain aspects provide a method for managing aircraft diversion, comprising receiving a request to divert an aircraft in flight away from an original destination airport, receiving real-time aircraft state data from an onboard computing device through an aircraft data gateway that connects the aircraft to at least one ground-based cloud service executed on cloud computing resources, invoking at least one model configured as one of the at least one ground-based cloud service to identify one or more candidate airports and associated suitability scores from a plurality of alternate airports based on the real-time aircraft state data and information regarding the plurality of alternate airports from multiple data sources, and transmitting the one or more candidate airports, as one or more recommendations for aircraft diversion, to an avionics system of the aircraft for presentation to a pilot, wherein two or more candidate airports are ordered from most suitable to least suitable based on the suitability scores.

Other aspects provide processing systems configured to perform the aforementioned method as well as those described herein; non-transitory, computer-readable media comprising instructions that, when executed by a processors of a processing system, cause the processing system to perform the aforementioned method as well as those described herein; a computer program product embodied on a computer readable storage medium comprising code for performing the aforementioned method as well as those further described herein; and a processing system comprising means for performing the aforementioned method as well as those further described herein.

To the accomplishment of the foregoing and related ends, certain illustrative aspects of the claimed subject matter are described herein in connection with the following description and annexed drawings. These aspects are indicative of several ways in which the subject matter may be practiced, all of which are intended to be within the scope of the claimed subject matter. Other advantages and novel features may become apparent from the following detailed description when considered in conjunction with the drawings.

### DESCRIPTION OF THE DRAWINGS

The appended figures depict certain aspects and are, therefore, not to be considered limiting of the scope of this disclosure.

FIG. 1 depicts a high-level overview of an example implementation of aircraft diversion.

FIG. 2 is a block diagram of an example aircraft diversion system.

FIG. 3 depicts an example interface and visualization.

FIG. 4 is a block diagram illustrating an example interaction between multiple systems.

FIG. 5 is a flow chart diagram illustrating an example method for aircraft diversion.

FIG. 6 depicts an example processing system with which aspects of the subject disclosure can be performed.

FIG. 7 depicts a block diagram of an example avionics system.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the subject disclosure provide apparatuses, methods, processing systems, and computer-readable mediums for aircraft diversion management.

Aircraft diversion refers to situations in which an aircraft cannot continue to a planned destination and needs to land at an alternate airport. Aircraft diversion encompasses emergency situations (e.g., in-flight emergencies) and non-emergency situations (e.g., deviations). Emergency situations typically involve a threat to the safety of the aircraft or its occupants and dictate immediate action to identify an airport for an emergency landing. Examples of in-flight emergencies include engine failure, fire, or a medical emergency. Non-emergency situations are not immediate threats to safety and may be prompted by adverse weather conditions, air traffic congestion, or a need to refuel, among other things. While non-emergency situations still require identification of an alternate airport, the decision-making process is less time-critical than in the case of an in-flight emergency. Traditionally, selecting an alternate airport for diversion is primarily based on the proximity of an airport to the current location and remaining fuel. Pilots communicate with air traffic control to identify the closest suitable airport. The decision is often made without a comprehensive consideration of other factors, such as weather conditions, runway length, and medical emergency requirements. Consequently, an alternate airport may be selected that is not the best choice. For example, an aircraft could land at an airport with unfavorable weather conditions, insufficient runway length, or a lack of specialized medical facilities, compromising the safety and efficiency of the diversion. Further, absent a thorough assessment of factors such as weather, traffic, and runway conditions, an alternative airport may not be the most fuel-efficient option, which increases the risk of the aircraft running out of fuel.

Disclosed aspects pertain to managing aircraft diversion by invoking a model configured as a ground-based cloud service to identify candidate airports based on real-time aircraft state and information regarding a plurality of alternative airports from multiple data sources and transmitting the one or more candidate airports, as recommendations for aircraft diversion, to an avionics system for presentation to a pilot. The real-time aircraft data can be submitted through an onboard computing device through an aircraft data gateway that connects the aircraft to a ground-based service executed on cloud computing resources. Real-time aircraft state data can include the current position, altitude, and heading, remaining fuel or battery levels, and any detected mechanical issues or emergency conditions. Information regarding alternate airports can include alternate airports and details such as runway specifications, weather forecasts, available medical facilities, and temporary restrictions, among other things. The model can then analyze data and determine one or more candidate airports that best match based on all factors and generate a ranked list of recommended airports. In accordance with one aspect, a suitability score is determined for each alternate airport, which is a numerical representation that quantifies the appropriateness or desirability of an alternate airport for aircraft diversion based on a comprehensive evaluation of multiple factors. The suitability score can serve as a metric to identify the best candidate airport or order a number of candidate airports, for example, from most suitable to least suitable.

Employment of a data-driven approach to aircraft diversion overcomes limitations of traditional techniques that rely on a limited number of factors and manual communication with air traffic controllers. The data-driven approach is a more comprehensive solution that incorporates real-time aircraft data with wide-ranging data regarding alternate airports, designed to enhance the safety and efficiency of an aircraft diversion management process by automatically providing the best matching options. Further, employing a ground-based service as opposed to an entirely onboard system provides many benefits including widespread compatibility across aircraft platforms, an ability to scale to accommodate a fleet of aircraft, reduction of onboard computing requirements, avoiding significant upgrades, and leveraging adaptable external data sources to provide a more comprehensive and accurate analysis of diversion options.

As used herein, “aircraft” refers to any machine or device capable of flight including conventional fixed-wing aircraft as well as unmanned aerial vehicles (UAVs) and urban air mobility (UAM) vehicles. The term “airport,” as used herein, refers to any place where aircraft can take off and land, including vertiports, heliports, and traditional airports. Further, the term “pilot” refers to an individual responsible for operating an aircraft but also encompasses an autonomous flight control system, such as those associated with UAVs.

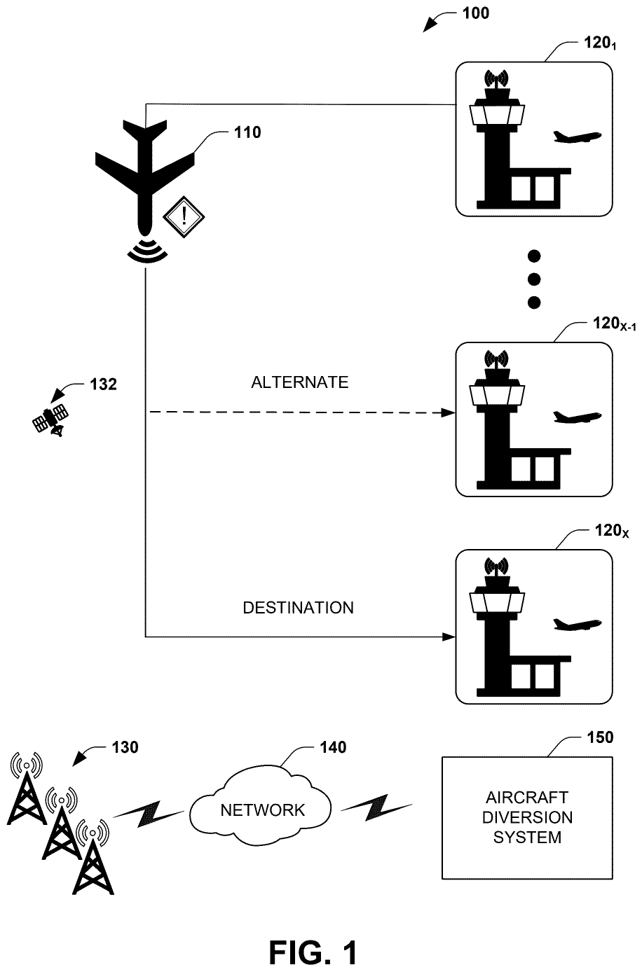

FIG. 1 depicts a high-level overview of an example implementation 100 of aspects associated with improved aircraft diversion with a data-driven automated approach. The implementation includes an aircraft 110, a plurality of airports 120₁₋ₓ, ground-based communication equipment 130, satellite 132, network 140, and aircraft diversion system 150.

The aircraft 110 refers to any machine capable of and designed for flight. Although aircraft 110 is depicted as a fixed-wing aircraft that relies on wings and forward motion for flight, other machines are also contemplated. For example, aircraft 110 can be a rotary-wing aircraft, such as a helicopter, which generates lift through spinning rotors, or a hybrid aircraft, such as tilt rotors, which combines elements of both fixed-wing aircraft and rotary-wing aircraft. Additionally, unmanned aerial vehicles (UAVs or drones) that operate autonomously or remotely for recreational, commercial, or military purposes are aircraft. Further, aircraft 110 can refer to electric Vertical Takeoff and Landing (eVTOL) vehicles designed for urban air mobility utilizing electronic propulsion for vertical flight. Other embodiments can include supersonic jets and lighter-than-air vehicles, such as airships, among other things.

The plurality of airports 120₁₋ₓ (hereinafter referred to singularly as airport 120 and collectively as airports 120) comprise a number (“x”) of facilities designated for the arrival, departure, and maintenance of aircraft 110. Airport 120 can be equipped with runways, terminals, control towers, and support infrastructure to accommodate cargo, passengers, or both. Airport 120 can also refer to a vertiport. A vertiport is a specialized facility designed to support takeoff, landing, charging, and maintenance of vertical takeoff and landing aircraft, such as eVTOL vehicles often utilized for urban air mobility. A vertiport can range from a simple landing pad to a complex hub equipped with aircraft maintenance facilities and charging stations. In one instance, a vertiport can be incorporated into a traditional airport. However, traditional airports occupy a large amount of space to support traditional fixed-wing aircraft and thus are often located outside cities due to the space required. By contrast, vertiports occupy much less space than traditional airports and can be in urban areas, such as on rooftops or near transportation hubs.

Ground-based communication equipment 130 refers to infrastructure and devices configured to enable transmission, reception, and relay of signals between airborne and terrestrial systems. For example, ground-based communication equipment 130 can include radio towers, satellite ground stations, radar systems, and data link terminals that support voice, data, and telemetry communication for aircraft. Such equipment enables air traffic control communications, satellite tracking, wireless communication, and navigation assistance, among other things.

Network 140 can be a local area or wide area network such as the Internet. Various systems and platforms can utilize the network to collect, process, and distribute data. In accordance with one embodiment, the ground-based communication equipment 130 can utilize the network 140 as a redundant or primary data relay method to route information between remote monitoring centers. Further, network 140 can support cloud computing and real-time analytics. Furthermore, eVTOL aircraft can rely on cloud-based internet connections (as well as 5G wireless) for real-time navigation, traffic management, and autonomous operations.

Aircraft diversion system 150 is configured to identify alternate airport recommendations during in-flight emergencies or non-emergency deviations. Aircraft diversion system 150 combines real-time data from an aircraft including current state information and any detected issues and comprehensive data regarding alternate airports, weather forecasts, and other relevant data from multiple data sources. Aircraft diversion system 150 can analyze the combined data to identify the most suitable diversion options based on a variety of factors. Aircraft diversion system 150 can subsequently generate and transmit a ranked list of one or more recommended alternate airports to an aircraft pilot, for example, through an onboard avionics system, or external avionics system or a control device associated with remote aircraft operation. In accordance with one aspect, the aircraft diversion system 150 can be implemented as a ground-based network-accessible or cloud service. As a result, onboard aircraft systems need not be updated to exploit the benefits of the aircraft diversion system 150. Furthermore, the aircraft diversion system 150 can easily scale to accommodate one or more fleets of aircraft.

As illustrated, aircraft 110 departs airport 120₁ for airport 120ₓ. During the flight, an unforeseen situation occurs, for example, regarding the proper functioning of aircraft 110 or the health of an aircraft passenger or crew member, that dictates the flight be diverted. Responsive to this situation, a request can be submitted to aircraft diversion system 150 automatically or by pilot request. The request can be transmitted from the aircraft to the ground-based communication equipment 130, in one instance by satellite 132, which can subsequently be provided to the aircraft diversion system 150 by way of network 140. In accordance with one aspect, the request includes identification of the cause of the request, such as a medical emergency or mechanical failure, as well as details, such as the type of medical emergency or the part that failed.

In response to receiving the request to divert the aircraft from its original destination airport and obtaining real-time aircraft state data from an onboard computing device, a model is invoked that is configured to identify one or more candidate airports from a plurality of airports based on the aircraft state data and information regarding alternate airports. In one instance, the model can be a multifactor optimization model, such as a weighted sum model that assigns weights to factors and a sum of weights to airports to identify an optimal choice. In another instance, the model can be an artificial intelligence model trained to recommend alternate airports, such as a rule-based expert system, supervised machine learning model, reinforcement learning model, or deep learning model, among others. Aircraft diversion system 150 can output one or more alternate airports 120 as recommendations. In one instance, multiple alternate airports can be organized in order, such as a ranked list, based on a suitability score or other metric that quantifies the appropriateness of an alternative airport based on multiple factors.

Aircraft diversion system 150 can transmit one or more candidate airports to the aircraft and crew through an onboard or external avionics system. A pilot can review one or more recommended alternate airports and optionally select one of the alternative airports. Selecting a recommended alternate airport can initiate an update of the avionics system to reroute aircraft 110 from the destination airport to the selected alternate airport. As illustrated, the aircraft can be diverted to alternate airport 120ₓ₋₁.

In accordance with one aspect, the aircraft diversion system may also interact with air traffic control in various ways. In one instance, aircraft diversion system 150 can notify air traffic control of a diversion request and provide information regarding recommended alternate airports. Further, the aircraft diversion system 150 can facilitate coordination of clearance to divert to a selected alternate airport, reducing the workload of both the pilot and air traffic controllers. Furthermore, aircraft diversion system 150 can be communicatively coupled with air traffic control and may receive feedback or additional information that can be factored into a recommendation; for example, a runway may be temporarily closed for repair or deicing. Overall, the aircraft diversion system 150 can be configured to integrate with air traffic control systems to allow a smooth exchange of information and coordination of a diversion process. Such collaboration can enhance overall process efficiency and safety of aircraft diversion while also reducing the manual workload of both pilots and air traffic control personnel, which is especially significant when concurrently dealing with an emergency in which time is of the essence.

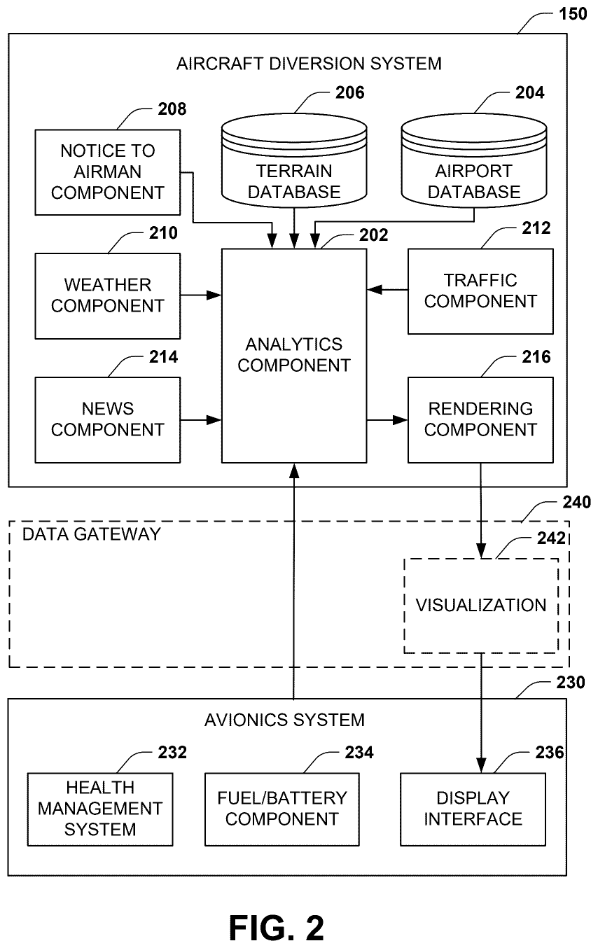

FIG. 2 depicts an example aircraft diversion system 150 in further detail. Further, FIG. 2 depicts the interaction of the aircraft diversion system 150 with an avionics system 230 through a data gateway 240. Aircraft diversion system 150 includes analytics component 202 communicatively coupled to various sources of data, including avionics system 230, airport database 204, terrain database, notice to airmen or air missions 208, weather component 210, traffic component 212, and news component 214.

Analytics component 202 is configured to identify one or more airports best suited for diversion of an aircraft. In accordance with one aspect, analytics component 202 can perform multifactor optimization to identify the one or more airports as a recommendation. A multifactor optimization model can be employed to consider a variety of weighted criteria to determine the best alternative airport or set of top alternative airports rather than relying on a single factor such as proximity to another airport or remaining fuel. As an example, a multifactor optimization model can utilize a weighted sum model that applies relative weight to different factors, such as remaining fuel, runway length, weather conditions, availability of specialized medical facilities, and air traffic. Analytics component 202 can compute a weighted score, or suitability score, for airports by applying weights to each factor and computing a sum of the weighted factors as the weighted score, with the greatest weighted score being ranked as the most optimal choice of airport for diversion.

Other models can also be employed alone or in combination with other models by analytics component 202 to recommend one or more alternate airports. For instance, artificial intelligence models can be employed, including rule-based expert systems, machine learning models, reinforcement learning models, and deep learning models. A rule-based expert system can encode the knowledge of an expert (e.g., pilot, air traffic controller) as predefined rules and utilize the rules and heuristics to recommend an airport or set of airports for aircraft diversion given data regarding the aircraft and airports. A machine learning model can be trained based on past aircraft diversions and outcomes of alternate airport selections. A trained model can then be utilized or invoked to predict the most suitable alternate airport or set of airports for a given situation. A reinforcement learning model can be trained by incorporating various factors into state and reward functions such that the model learns a policy that maximizes cumulative reward. For example, the model can learn from past diversion decisions and employ such knowledge to identify alternative airports. A deep learning model can be utilized to make predictions regarding weather and traffic, for example, which can be utilized to perform multifactor optimization by way of a multifactor optimization model, machine learning model, or other model.

The analytics component 202 can utilize data provided by the airport database 204 to identify one or more alternate airports for an aircraft diversion. Airport database 204 can include information about each airport of a plurality of airports. For example, airport database 204 can include runway specifications, facility information, medical facilities, operational status, traffic and congestion data, and location data, among other things. Runway specifications can include length, width, surface type, weight-bearing capacity or aircraft restrictions, runway lighting, and navigational aids. Facility information can include the availability of terminal buildings and hangers, the presence of air traffic control tower, and the availability of fueling, maintenance, and other support services. Medical facilities pertain to the availability and capability of nearby hospitals, emergency medical centers, and other healthcare facilities as well as proximity and accessibility of such medical facilities to an airport. Operational status can include identification of any temporary closures, runway maintenance, or other restrictions. Traffic and congestion data can pertain to information on historical or current air traffic volume and congestion levels at an airport. Location data can correspond to a precise location, such as the coordinates (e.g., latitude and longitude) of the airport as well as the country, state, and city.

Terrian database 206 can include information about the terrain and obstacles in the vicinity of alternate airports. Examples of such information can include terrain profiles, obstacle data, and clearance requirements. A terrain profile can include a representation of the terrain including slopes and sudden changes in elevation. Obstacle data can include information about natural or man-made obstacles, such as mountains, bodies of water, buildings, and wind turbines, that could pose a hazard to aircraft operation. Clearance requirements can provide details regarding a minimum obstacle clearance altitude and distance requirements for different obstacles. Although illustrated in a separate database, the terrain database information can be incorporated into the airport database 204 in accordance with one aspect. Information provided by the terrain database can be helpful in evaluating the feasibility and risk of landing at a particular airport, especially during emergency situations when an aircraft may have limited maneuverability.

Notice to airmen or air missions (NOTAM) 208 is a component that receives, retrieves, or otherwise obtains notices for pilots and aviation personnel about temporary or permanent changes in airspace, airports, and hazards, among other things that can affect flight safety. For example, a notice can indicate that airspace is restricted for military operations or head-of-state travel. As another example, a runway may be closed for maintenance between set dates. Notices provide timely information that facilitate accurate and up-to-date recommendations during an aircraft deviation event. In accordance with one aspect, notices can be input and saved to the airport database 204 rather than or in addition to being a separate component.

Weather component 210 is configured to receive, retrieve, or otherwise obtain one or more weather reports. For example, weather reports can be obtained from a service, on-site weather sensors, or both. A weather report can indicate current conditions such as the temperature, humidity, wind speed, direction, and gusts, visibility, cloud cover, precipitation (e.g., rain, snow), and any adverse weather phenomena (e.g., thunderstorms, icing, turbulence). Further, a weather report can indicate forecasted weather conditions, as well as aviation-specific weather conditions (e.g., runway visual range, icing conditions, cloud base and top heights). Probability estimates can also be provided in a weather report, such as the probability or likelihood of specific weather events (e.g., thunderstorms, fog). Weather information can be utilized by the analytics component 202 to assess the suitability of alternate airports based on current and anticipated weather conditions during aircraft diversion.

Traffic component 212 is configured to predict air traffic conditions at alternate airports. Current air traffic conditions can be determined including the number of aircraft, their positions, and their movements. In accordance with one aspect, current air traffic conditions can be received, retrieved, or otherwise obtained from an air traffic control system. One or more predictive models trained on historical traffic patterns and congestion levels can be invoked to forecast expected traffic conditions at alternate airports during a time frame when a diverted aircraft is likely to arrive. Predicted traffic data can be utilized by the analytics component 202 to prioritize airports based on expected availability to handle a diverted aircraft given predicted traffic and congestion.

News component 214 is configured to monitor news sources for events that could impact the suitability of an alternate airport to handle a diverted aircraft. For example, the news component 214 can continuously monitor media outlets for airport closures, security incidents, or other airport disruptions. Analytics component 202 can accept news from the news component 214 and utilize news as context data to adjust recommendation of suitable alternative airports based on the latest developments and potential disruptions. Exploiting real-time contextual information improves recommendations regarding alternate airports in rapidly changing and unexpected situations.

Analytics component 202 can also receive aircraft state data from an onboard avionics system 230, which refers to a collection of electronic systems utilized for monitoring and communication, among other functions for safe and efficient aircraft operation. The avionics system can continuously monitor the state of an aircraft including altitude, speed, engine performance, and fuel usage, among other things. The avionics system 230 can communicate aircraft state data to analytics component 202 through data gateway 240.

Data gateway 240 is configured to enable communication and data exchange between avionics system 230 and aircraft diversion system 150, and more particularly, analytics component 202. In accordance with one aspect, data gateway 240 collects and aggregates data from avionics system 230 and securely transmits the aggregated data from the avionics system 230 to the aircraft diversion system 150. Data gateway 240 can also be configured to support bi-directional communication such that data gateway 240 can transmit as well as receive data. Data gateway 240 thus acts as a data communication conduit between an aircraft and the aircraft diversion system 150.

Avionics system 230 includes health management system 232, fuel/battery component 234, and display interface 236. Health management system 232 is configured to monitor the health of an aircraft's avionics, propulsion, structural, and environmental systems. Data can be collected from onboard sensors on engines, electrical systems, and structures, among others. This data can be analyzed to detect anomalies or abnormal system behavior and alert a pilot and maintenance crews. This health data can be provided as state data and transmitted to the aircraft diversion system.

Fuel/battery component 234 is configured to monitor an aircraft's fuel or battery levels (e.g., fuel quantity, charge) and, optionally, various other data (e.g., flow rate, pressure, temperature, voltage, current, system status) from sensors and transmit such data to the aircraft diversion system 150 and, more particularly, analytics component 202. Consequently, energy constraints can be factored into selection of an alternate airport.

Display interface 236 is configured as an interaction point between pilots and an aircraft's electronic systems. The interface can enable real-time monitoring, control, and data visualization of aircraft state and functionality. In accordance with one aspect, the interface can provide a display screen and enable interaction by way of touch, physical buttons, or voice, for example. In one instance, the interface can display one or more alternate airports associated with aircraft diversion.

Rendering component 216 is configured to generate one or more visualizations 242 to assist a pilot in the decision-making process regarding diverting an aircraft to an alternate airport. More specifically, rendering component 216 can produce a graphical representation of recommendations, such as a list of recommended alternate airports identified by the analytics component 202. Further, the representation can include alternate airports on a map with relevant information such as runway details, weather conditions, and estimated time of arrival, among other things. In accordance with one aspect, a visualization 242 can be interactive allowing a pilot to explore and interact with recommended alternate airports, for example, by zooming, panning, and accessing additional details about an airport. The visualization 242 can be transmitted to the avionics system 230 for display by the display interface 236 by way of the data gateway 240.

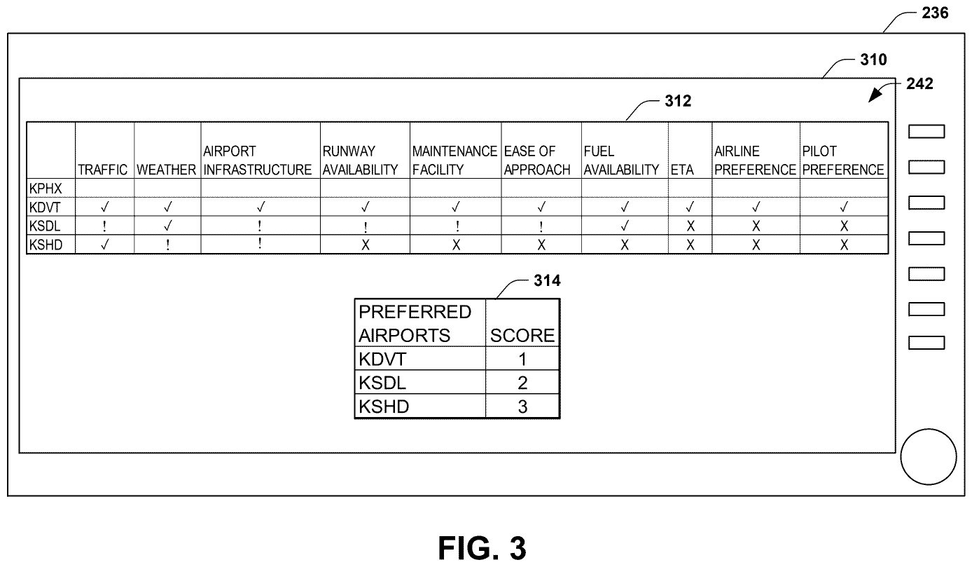

FIG. 3 depicts an example display interface 236 comprising a display 310. As shown, interface 236 presents visualization 242 on display 310. Visualization 242 can be generated by aircraft diversion system 150 of FIG. 1 and FIG. 2, and more particularly, rendering component 216 of FIG. 2. The visualization 242 includes two tables, table 312 and table 314. Table 312 includes columns representing various factors that contribute to determining a suitable alternate airport for aircraft diversion, including traffic, weather, airport infrastructure, runway availability, maintenance facility, ease of approach, fuel availability, estimated time of arrival, airline preference, and pilot preference. Rows represent airports, namely “KPHX,” “KDVT,” “KSDL,” and “KSHD.” Each airport and factor intersection specifies an extent to which a factor is satisfied. In accordance with one aspect, stop light colors green, yellow, and red can be utilized, where green indicates the factor is satisfied, yellow denotes somewhat satisfied, and red indicates not satisfied. As depicted, a checkmark (“✓”) corresponds to green, an exclamation mark (“!”) corresponds to yellow, and the letter “X” corresponds to red. Table 314 identifies airports and overall scores associated with the airports. A pilot can decide to divert an aircraft to a particular airport by selecting one of the airports in table 312 or table 314. Further functionality can be triggered after selection, such as requesting clearance for landing at the selected airport.

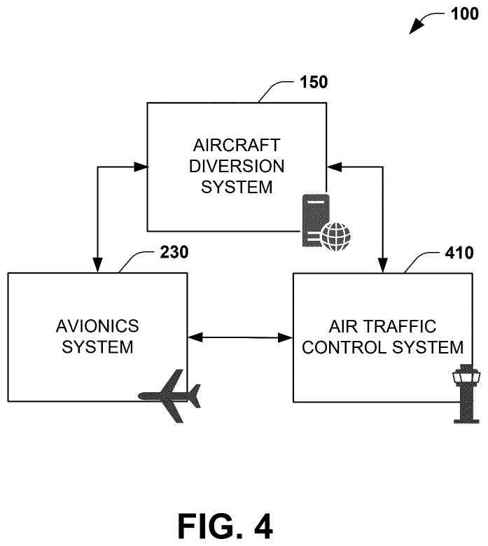

FIG. 4 is a block diagram illustrating an example interaction between multiple systems in accordance with an aspect of the subject disclosure. In accordance with one aspect, aircraft diversion system 150 can be implemented as a network or cloud service in accordance with a software as a service (SaaS) design in which the service is accessed and provided over a network such as the Internet. Avionics system 230 refers to collection of electronic and electrical systems and components installed within an aircraft responsible for various functions related to aircraft operations (e.g., navigation, communication, performance monitoring). As previously described, the aircraft diversion system 150 and the avionics system 230 can be communicatively coupled, for example, by way of a data gateway. The aircraft diversion system 150 can receive real-time state information regarding an aircraft and, responsive to a request to divert an aircraft from an original destination airport, can utilize the state information together with other information regarding airports and surrounding context to recommend one or more alternate airports. Air traffic control system 410 refers to various technological tools and communication equipment that enable air traffic controllers to monitor, coordinate, and direct the movement of aircraft within an airspace. For example, the air traffic control system 410 can include one or more of air space management systems, flight data processing systems, voice communications systems, and conflict resolution systems, among other things. Air traffic control system 410 is communicatively coupled to avionics system 230 of an aircraft by voice and datalink communication. Datalink communication can involve the exchange of digital data associated with flight plans, among other things. In accordance with an aspect of the subject disclosure, the aircraft diversion system 150 can also be communicatively coupled with the air traffic control system 410. In one instance, the aircraft diversion system 150 can trigger acquisition of clearance to land at a selected airport. Further, the aircraft diversion system 150 can also supply the air traffic control system 410 the same or similar information as is provided to the pilot to facilitate collaboration regarding expeditious selection of an alternate airport for landing. Alternatively, the aircraft diversion system 150 can be integrated into air traffic control system 410 and utilized to assist pilots with determining an alternate airport when aircraft diversion is requested.

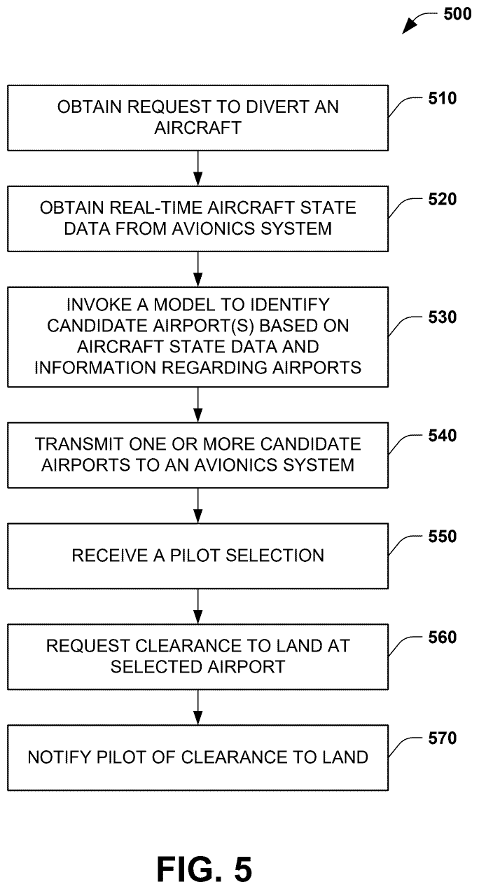

FIG. 5 depicts an example method 500 for aircraft diversion. In one aspect, method 500 can be implemented by the aircraft diversion system 150 of FIGS. 1, 2, 3, and 6.

Method 500 starts at block 510 with receiving, retrieving, or otherwise obtaining a request to divert an aircraft inflight away from an original destination or, in other words, a diversion request. A diversion request refers to communication initiated by an aircraft pilot or an aircraft's flight control system to indicate a request to deviate from a planned flight path and land at an alternate airport. In one instance, the diversion request can include a cause of the request (e.g., medical emergency, type of medical emergency, part failure). The diversion request can provide initial context and trigger a decision-making process in a timely manner to ensure a rapid response to a potential emergency.

Method 500 continues at block 520 with receiving, retrieving, or otherwise obtaining real-time aircraft state data from an onboard avionics system. The state data can include data from sensors onboard an aircraft monitoring an aircraft's position, altitude, speed, fuel/batter levels, and any detected mechanical or emergency conditions. In accordance with one aspect, an aircraft's avionics system can collect and aggregate real-time sensor data into a data package representing the current state, which is transmitted through a secure communication interface (e.g., Honeywell Forge) between the aircraft and a cloud-based platform for on-ground processing. Acquisition of real-time information enables an informed decision-making process based on current and comprehensive data regarding an aircraft.

Method 500 continues to block 530 by invoking a model to identify candidate airports based on the aircraft state data and information regarding airports (e.g., airport database). In accordance with one aspect, the model can perform multifactor optimization to identify one or more alternate airports that are suitable for diverting an airplane. In accordance with one embodiment, the model can correspond to an artificial intelligence model, such as a rule-based expert system, machine learning model, reinforcement learning model, deep learning model, or a combination thereof. By way of example, and not limitation, a machine learning model can be trained on historical data of past aircraft deviations and outcomes of alternate airport selection. The trained model can then utilize the acquired knowledge to predict the most suitable alternate airport given a scenario. In accordance with one aspect, a machine learning model can determine a suitability score or other metric that quantifies the appropriateness of an aircraft for diversion based on a comprehensive evaluation of multiple weighted factors (e.g., fuel/battery, runway specifications, weather conditions, medical facility availability, proximity). The suitability score can enable a quantitative process to compare and rank alternate airports for diversions.

In one instance, the machine learning model can be based on linear regression. Of course, other machine learning algorithms may be utilized. Employing artificial intelligence models enables determining suitable alternate airports based on numerous factors expeditiously utilizing a multi-factor optimization approach.

Method 500 continues at block 540 with transmitting one or more candidate airports, as recommendations for aircraft diversion, to a pilot, for example, through an onboard or external avionics system 230. The model can be configured to identify one or more candidate airports that are suitable for diverting a particular aircraft. In accordance with one embodiment, a ranked list of multiple candidate airports can be prepared and transmitted to the avionics system. The avionics system can display the candidate airports to the pilot for review and consideration. For example, consider the avionics system 230 of FIG. 3.

Method 500 proceeds to block 550 with receiving a pilot selection. For example, utilizing a selection mechanism provided by an avionics system, the pilot can select one of the candidate airports from a list of one or more alternate airports for flight diversion. Consequently, the process can adapt to a pilot's preferences, ensuring the final decision aligns with the pilot's expertise and experience.

Method 500 continues at block 560 with requesting clearance to land at the selected airport. For example, method 500 can interact with air traffic control systems or individuals to request clearance from air traffic control for an aircraft to land at a selected alternate airport responsive to the pilot selection. Obtaining clearance is streamlined by coordination between an aircraft and air traffic control.

Method 500 continues at block 570 with notifying the pilot of clearance granted to land at the selected airport.

Method 500 provides beneficial technical effects. For instance, the method 500 exploits real-time data, a model such as an AI model, and collaborative decision-making to enhance safety and efficiency of an aircraft diversion process, ultimately benefiting pilots and aircraft controller during an atypical situation when time is of the essence and mistakes are possible absent comprehensive data processing.

Note that FIG. 5 is just one example of a method, and other methods including fewer, additional, or alternative operations are possible consistent with this disclosure.

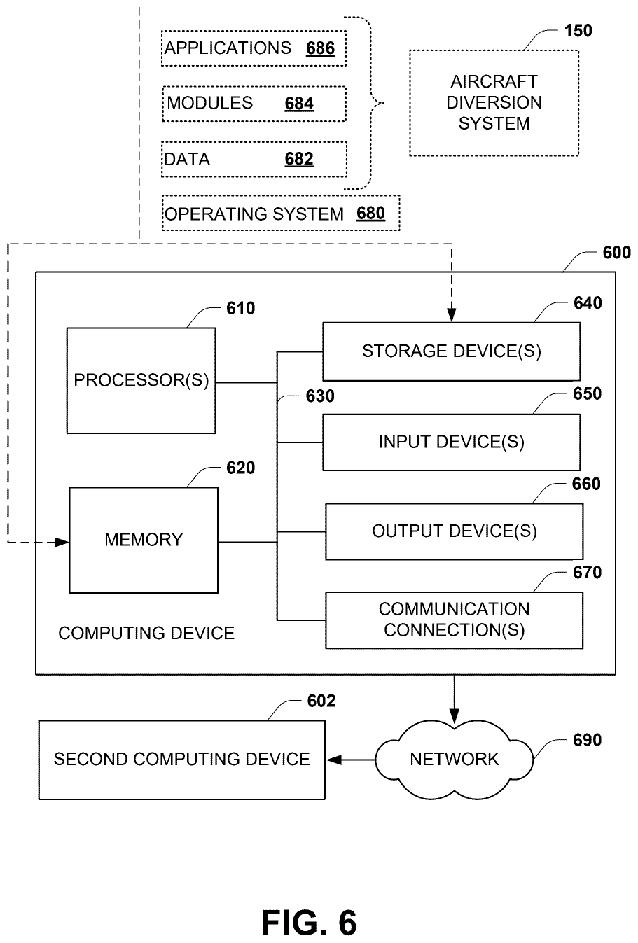

FIG. 6 depicts an example processing system configured to perform various aspects described herein, including, for example, method 500 as described above with respect to FIG. 5.

To provide context for the disclosed subject matter, FIG. 6, as well as the following discussion, are intended to provide a brief, general description of an example processing system in which various aspects of the disclosure can be implemented. The example processing system is solely an example and is not intended to suggest any limitation on the scope of use or functionality.

FIG. 6 depicts an example computing device 600. The computing device 600 includes at least one processor(s) 610, memory(s) 620, bus 630, storage device(s) 640, input device(s) 650, output device(s) 660, and network interface(s) 670. Bus 630 communicatively couples at least the above device constituents. In the simplest form, computing device 600 includes one or more processor(s) 610 coupled to at least one memory 620, wherein the one or more processors 610 execute computer-executable instructions stored in the at least one memory 620 and retrieved from one or more storage device 640.

Bus 630 may be formed from any medium capable of transmitting a signal, such as conductive wires, conductive traces, optical waveguides, connectors, or the like. In one embodiment, bus 630 comprises a combination of conductive traces, conductive wires, connectors, and cooperate to permit the transmission of electrical data signals to components such as the processor(s) 610, memory(s) 620, storage device(s) 640, input device(s) 650, output device(s) 660, and network interface(s) 670.

Processor or processing circuitry 610 can be implemented with a general-purpose processor, a microprocessor, a digital signal processor (DSP), an application-specific integrated circuit (ASIC), a field-programmable gate array (FPGA), or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. Processor(s) 610 can also be implemented as a combination of computing devices, for example, a combination of a DSP and a microprocessor, a plurality of microprocessors, multi-core processors, one or more microprocessors in conjunction with a DSP core, or any other such configuration. In certain embodiments, processor(s) 610 are representative of one or more central processing units (CPUs), graphics processing unit (GPUs), tensor processing unit (TPUs), accelerators, and other processing devices.

Computing device 600 can include or otherwise interact with a variety of computer-readable media to facilitate control of computing device 600 to implement one or more aspects of the disclosed subject matter. The computer-readable media can be any available media accessible to computing device 600 and includes volatile and nonvolatile media and removable and non-removable media. Computer-readable media can comprise two distinct and mutually exclusive types: storage media and communication media.

Storage media includes volatile and nonvolatile, removable, and non-removable media implemented in any method or technology to store information, such as computer-readable instructions, data structures, program modules, or other data. Storage media includes memory devices (e.g., random access memory (RAM), read-only memory (ROM), electrically erasable programmable read-only memory (EEPROM)), magnetic storage devices (e.g., hard disk, floppy disk, cassettes, tape), optical disks (e.g., compact disk (CD), digital versatile disk (DVD)), and solid-state devices (e.g., solid-state drive (SSD), flash memory drive (e.g., card, stick, key drive)), or any other like mediums that store, as opposed to transmit or communicate, the desired information accessible by computing device 600. Accordingly, storage media excludes modulated data signals as well as that which is described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media.

Memory(s) 620 and storage device(s) 640 are examples of computer-readable storage media. Depending on the configuration and type of computing device, memory(s) 620 can be volatile (e.g., random access memory (RAM)), nonvolatile (e.g., read-only memory (ROM), flash memory. . . ), or some combination of the two. By way of example, the basic input/output system (BIOS), including basic routines to transfer information between elements within the computing device 600, such as during start-up, can be stored in nonvolatile memory. By contrast, volatile memory can act as external cache memory to facilitate processing by the processor(s) 610.

The storage device(s) 640 include removable/non-removable, volatile/nonvolatile storage media for storing vast amounts of data relative to the memory(s) 620. For example, storage device(s) 640 include, but are not limited to, one or more devices such as a magnetic or optical disk drive, floppy disk drive, flash memory, solid-state drive, or memory stick.

Memory(s) 620 and storage device(s) 940 can include or have stored therein operating system 680, one or more applications 686, one or more program modules 684, and data 682. Operating system 680 can control and allocate resources of the computing device 600. Applications 686 include one or both of system and application software and can exploit management of resources by the operating system 680 through program modules 684 and data 682 stored in memory(s) 620, storage device(s) 640, or both to perform one or more actions. Accordingly, applications 686 can turn a general-purpose computer into a specialized machine according to the logic provided.

Input device(s) 650 and output device(s) 660 can be communicatively coupled to the computing device 600. By way of example, input device(s) 650 can include a pointing device (e.g., mouse, trackball, stylus, pen, touchpad), keyboard, joystick, microphone, voice user interface system, camera, sensor, and a global positioning satellite (GPS) receiver and transmitter, among other things. Output device(s) 660 can correspond to a display device (e.g., liquid crystal display (LCD), light emitting diode (LED), plasma, organic light-emitting diode display (OLED). . . ), speakers, voice user interface system, printer, and vibration motor, among other things. The input device(s) 650 and output device(s) 660 can be connected to the computing device 600 by way of a wired connection (e.g., bus), wireless connection (e.g., Wi-Fi, Bluetooth), or a combination thereof.

Computing device 600 can also include a network interface(s) 670 to enable communication with at least a second computing device 602 utilizing a network 690. Network interface(s) 670 can include wired or wireless communication mechanisms to support network communication. The network 690 can correspond to a personal area network (PAN), local area network (LAN), or a wide area network (WAN), such as the Internet. In one instance, the computing device 600 can correspond to a network-connected or cloud server executing the aircraft diversion system 150 (FIGS. 1, 2, and 4). The second computing device 602 can correspond to or implement avionics system 230 (FIGS. 2 and 4) or air traffic control system 410 (FIG. 4) that interacts with the computing device 600.

Note that FIG. 6 is just one example of a processing system consistent with aspects described herein, and other processing systems having additional, alternative, or fewer components are possible consistent with this disclosure.

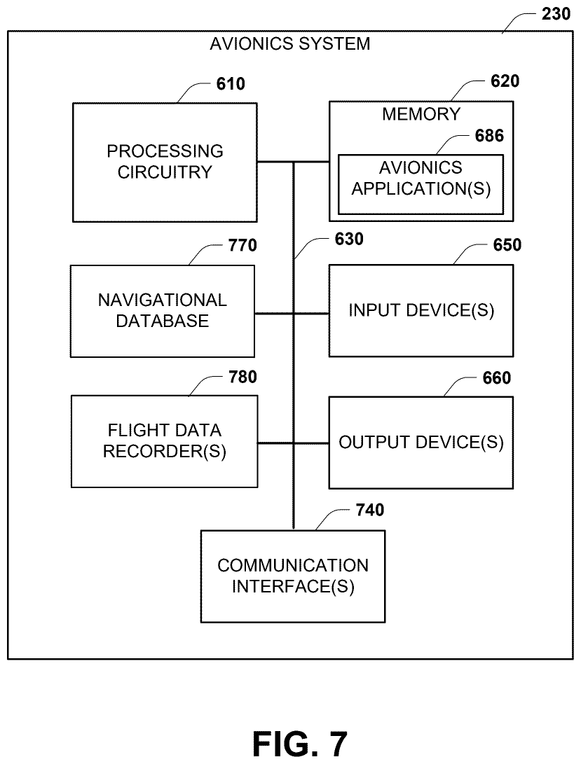

FIG. 7 illustrates a more detailed example of avionic system 230. Avionics system 230 is a specialized computing device 600 configured to store and execute avionics applications. In the example of FIG. 7, avionics system 230 includes processing circuitry 610, memory 620, which stores avionics applications 686, communication interface(s) 670 to communicate with other devices, input device(s) 650, output device(s) 660, navigational database 710, and flight data recorder(s) 720. The aforementioned components of avionics 230 may be connected to one another through bus 630, which generally represents one or more busses and is intended to generically represent all the electrical and data connectivity of internal components included within avionics system 230.

Processing circuitry 610 implements the functionality of and/or executes the instructions associated with avionics applications 686. Processing circuitry 610 may be implemented as any of a variety of suitable circuitry that includes a processing system, such as one or more integrated circuits, microprocessors, digital signal processors (DSPs), application specific integrated circuits (ASICs), field programmable gate arrays (FPGAs), discrete logic, software, hardware, firmware or any combinations thereof. When the techniques are implemented partially in software, avionics system 230 may store instructions for the software in a suitable computer-readable medium (e.g., memory 620) and execute the instructions in hardware using processing circuitry 610 to perform the techniques of this disclosure.

Memory 620 is intended to represent all memory included within avionics system 230. In some implementations, memory 620 may include a plurality of separate devices and memory units. These memory devices and memory units may include volatile memory, such as RAM, and/or non-volatile memory, such as ROM and storage media. Examples of RAM include DRAM, including SDRAM, MRAM, and RRAM. Examples of storage media include solid-state storage media (e.g., solid state drives and/or removable flash memory), optical storage media (e.g., optical discs), and/or magnetic storage media (e.g., hard disk drives). The avionics applications 686 may be stored in any volatile and/or non-volatile memory component of memory 620.

Communication interface(s) 740 generally represents all hardware, for example, transceiver circuitry, within avionics 230 for communicating with external devices either on the ground or while in flight. Communication interface(s) 740 may facilitate communication with external devices through one or more wired and/or wireless network connections by transmitting and/or receiving signals on the one or more networks. Examples of communication interface(s) 740 include a network interface card (e.g. such as an Ethernet card), an optical transceiver, a radio frequency transceiver, a GPS receiver, or any other type of device that can send and/or receive information. Other examples of communication interface(s) 740 may include short wave radios, cellular data radios, wireless network radios, as well as USB controllers. Examples of communication interface(s) 740 for in-flight communication include a very high frequency (VHF) radio, a high frequency (HF) radio, or a satellite communication (SATCOM) radio.

Examples of communication interface(s) 740 used for data links include an aircraft communications addressing and reporting system (ACARS) for providing a digital data link system that allows for the exchange of messages between the aircraft and ground stations for purposes such as flight plan updates, weather information, and maintenance reports. Another example of communication interface(s) 740 used for data links include controller-pilot data link communications (CPDLC), which allows air traffic control to send instructions and receive acknowledgments from pilots via text messages. Communications interface(s) 740 may also include an automatic dependent surveillance-broadcast transponder. The various examples of communications interfaces listed above represent a non-exhaustive list of the types of communication interfaces that may be included in communication interface(s) 740. In accordance with one aspect, the communication interface(s) 740 can be utilized to transmit real-time aircraft data to the aircraft diversion system 150.

Avionics system 230 also includes input device(s) 650 and output device(s) 660. Examples of input device(s) 650 include control display units (CDUs) with alphanumeric keypads or touchscreens to enter flight plans, waypoints, and other necessary data. Input device(s) 650 may also include an FMS control panel for entering information to the FMS, such as route, altitude, and speed using dedicated buttons, knobs, and touchscreen interfaces. Input device(s) 650 may also include yoke or sidestick controls as well as touchscreen interfaces. Input device(s) 650 may also include rotary knobs for setting values for altitudes, speeds, and other parameters and toggle switches for selecting modes or turning systems on and off. In accordance with one aspect, the input device(s) 650 can be utilized to trigger diversion as well as select an alternate airport from one or more suggested alternate airports.

Examples of output device(s) 660 may include an electronic flight instrument display to provide visual representations of flight data, including altitude, airspeed, heading, and attitude. Output device(s) 660 may also include a Heads-Up Display (HUD) that projects critical flight information onto a transparent screen in the pilot's line of sight or other cockpit displays to show navigation maps, engine parameters, system statuses, and the like. Output device(s) 660 may also include engine instrumentation displays to display data on engine performance, such as temperature, pressure, and revolutions per minute (RPMs). Output device(s) 660 may also include audio panels to relay communication from radios and alerts from systems to the cockpit. Output device(s) 660 may also include an FMS display to show flight plan information and performance data, as well as a traffic collision avoidance system (TCAS) display to alert pilots to nearby aircraft and potential collision threats. According to one aspect, the output device(s) 660 may present recommended alternate airports responsive to a diversion request.

The various examples of input and output devices listed above represent a non-exhaustive list of the types of input and output devices that may be included in input device(s) 650 and output device(s) 660. Additionally, input and output functionality of avionics 230 may be facilitated by external devices that are separate from input device(s) 750 and output device(s) 760. For example, an electronic flight bag (EFB) device may be configured to input data to and output data for avionics 230.

Avionics applications 686 represent a suite of software tools that may be used by a pilot in managing flight operations and managing the aircraft while in flight. Avionics applications 686 includes flight management system (FMS) as well as other applications for communication, navigation, and monitoring within an aircraft. FMS may be configured to generate a flight plan and navigate an aircraft through the flight plan. A flight plan may, for example, include a departure location, destination location, a departure time, a desired arrival time, a desired flight duration, a desired altitude, a set of waypoints, an identification of weather structures to be avoided, a fuel load for the aircraft, a number of passengers on the aircraft, a desired speed, an identification of a runway, or other such flight-related information. Based on feedback from various navigation sensors on the aircraft, FMS may ensure that the aircraft is adhering to the flight plan. In this regard, FMS may be viewed as the custodian of the flight plan.

Avionics applications 686 may, for example, also include applications for processing and displaying weather radar data and presenting essential flight information such as altitude, airspeed, attitude, and heading to a pilot. Avionics applications 686 also include various safety applications related to surveillance systems (e.g., transponders to communicate the aircraft's identity and altitude to air traffic control and other aircraft, such as automatic dependent surveillance-broadcast (ADS-B) systems that provide real-time data to air traffic control and other aircraft). Avionics applications 686 may also include the software to manage various emergency systems (e.g., an emergency locator transmitter, flight data recorder, and cockpit voice recorder) and cabin management systems (e.g., passenger infotainment systems and environmental control systems). In accordance with one aspect, the avionics applications 686 can include the health management component 232, fuel/battery component 234, and display interface 236 as described in FIG. 2.

Navigational database 770 represents a specialized database that stores information needed by FMS for the navigation and operation of an aircraft for purposes such as flight planning, route management, and ensuring safe navigation throughout a flight. Navigational database 770 may, for example, store waypoints, airways, navigational aids, airport information, standard instrument departures (SIDs) and standard terminal arrival routes (STARs), route data, and flight plans. The waypoints represent information on predefined geographical locations used for navigation, including both en-route waypoints and arrival/departure waypoints. The airways are data-defining structured flight paths in the sky, including various air routes and connecting points. The navigational aids may, for example, be information on radio beacons, such as VHF Omnidirectional Range and Instrument Landing Systems that assist pilots in navigation. The airport information may, for example, include details about airports, including runway configurations, elevation, communications frequencies, and available approaches. SIDs and STARs may provide standardized paths for departures and arrivals. The route data may, for example, include information on preferred routes, including distance and estimated times. The flight data may be data regarding planned routes, altitudes, and waypoints for a specific flight. The locations of waypoints, airports, and navigational aids may, for example, be defined by geographical coordinates.

Navigational database 770 may also store information related to restrictions and procedures, performance data, and weather information. The restrictions and procedures may include airspace restrictions, no-fly zones, and specific procedures that need to be followed during flight. The performance data may include information related to aircraft performance, including altitude constraints and speed limits. The weather information may include relevant meteorological data that might affect flight paths, such as wind patterns or turbulence zones. Navigational database 770 may be regularly updated to reflect changes in air traffic regulations, airport information, and navigational aids to ensure pilots have current information for safe and efficient flight operations.

Although not explicitly shown in FIG. 7, avionics system 230 may include or be in communication with numerous other hardware components or hardware systems, such as a global positioning system (GPS) receiver, an inertial navigation system (INS) that includes gyroscopes and accelerometers to calculate position based on movement, weather radar for detecting weather patterns, engine monitoring systems, aircraft data recording systems, flight data recording systems, and other such systems. In some examples, avionics system 230 may be configured to utilize inputs from a variety of specialized sensors such as altitude sensors, airspeed sensors, attitude sensors, heading sensors, GPS sensors, temperature sensors, pressure sensors, fuel sensors, weight and balance sensors, navigation sensors, environmental sensors, collision avoidance sensors, and other such sensors.

Flight data recorder(s) 780 may be configured to record, and store in memory 620, flight data. In some examples, flight data recorder(s) 780 may have dedicated memory, meaning the memory that stores flight data is separate than, for example, the memory that stores avionics applications 722. Flight data recorder(s) 780 may include any combination of one or more flight data recorders including a quick access recorder, a deployable recorder, or a combined cockpit voice recorder and flight data recorder.

Flight data recorder(s) 780 may be configured to record flight dynamics and motion data. For example, flight data recorder(s) 780 may be configured to record the aircraft's altitude above sea level (i.e., altitude), the aircraft's speed relative to the surrounding air (i.e., airspeed), the aircraft's rate of ascent or descent (i.e., vertical speed), the direction the aircraft is pointed (i.e., heading), the aircraft's nose angle up/down and bank angle left/right (i.e., pitch and roll), the aircraft's deviation from a straight path or wind drift (i.e., yaw), and the aircraft's lateral, vertical, and longitudinal acceleration.

Flight data recorder(s) 780 may also be configured to record control surfaces and positioning data. For example, flight data recorder(s) 780 may be configured to record the aircraft's aileron position for controlling roll, the aircraft's elevator position for controlling pitch, the aircraft's rudder position for controlling yaw, the aircraft's flap positions for controlling changes in lift and drag (e.g., during takeoff, landing, and approach), the aircraft's spoiler positions for reducing lift and slowing the aircraft down, or the aircraft's slat positions for providing added lift during low-speed operations.

Flight data recorder(s) 780 may also be configured to record engine parameters. For example, flight data recorder(s) 780 may be configured to record the aircraft's engine output (e.g., engine thrust or power level), the aircraft engine's core and fan shaft speeds (i.e., N1 and N2 speeds), temperature of gases exiting the engine (e.g., exhaust gas temperature (EGT)), the rate at which fuel is consumed by each engine (i.e., fuel flow rate), oil Pressure, oil temperature, and thrust level set by the pilot (e.g., throttle position).

Flight data recorder(s) 780 may also be configured to record environmental conditions data. For example, flight data recorder(s) 780 may be configured to record outside air temperature, the presence of ice on wings or other critical surfaces, storm and weather information, and wind speed and direction.

Flight data recorder(s) 780 may also be configured to record aircraft systems and equipment data. For example, flight data recorder(s) 780 may be configured to record autopilot Status, such whether autopilot is engaged and what mode (altitude hold, heading mode, etc.) is being implemented. Flight data recorder(s) 780 may also be configured to record the position of the landing gear (e.g., up, down, or transit), brake pressure or braking force applied during landing, hydraulic pressure of braking systems, and cabin altitude and pressurization levels. Flight data recorder(s) 780 may also be configured to record electrical systems status, such as voltage, current, and operational state of systems.

Flight data recorder(s) 780 may also be configured to record flight path and navigation data, such as GPS position (e.g., latitude, longitude, and altitude coordinates), horizontal track and descent/ascent angles (i.e., flight path angle and track), speed relative to the ground (i.e., groundspeed), and navigation waypoints in the flight plan.

Flight data recorder(s) 780 may also be configured to record crew inputs. For example, flight data recorder(s) 780 may be configured to record control inputs, such as a pilot's inputs on yoke/stick, rudder pedals, and throttle. Flight data recorder(s) 780 may also be configured to record status or positions of switches (e.g., fuel pumps, anti-ice). Flight data recorder(s) 780 may also be configured to record communication controls, such as transponder codes, frequency changes, and communications status.

Flight data recorder(s) 780 may also be configured to record the status of warning and alarm systems, such as the status of alarms such as stall warnings, overspeed warnings, or terrain awareness warnings. Flight data recorder(s) 780 may also be configured to record engine and system alerts, such as malfunction notifications related to engine failures, low hydraulic pressures, or other such warnings. Flight data recorder(s) 780 may also be configured to record crew announcements and chimes. In one instance, flight data recorded by the flight data recorder can be provided to the aircraft diversion system 150.

In accordance with one aspect, the avionics system 230 can reside onboard an aircraft and communicate with the aircraft diversion system 150 through the data gateway 240, as illustrated in FIG. 2. Alternatively, the system may be either onboard or may be an external controller device.

Further, the focus of discussion has been the presentation of one or more recommended alternate airports to a pilot for selection. In one instance, an aircraft can utilize a pilot-free autonomous flight control system. In such a situation, a single recommendation can be provided to the autonomous flight control system, such as the top-ranked alternate airport for diversion. Of course, if the autonomous flight control system is capable of reasoning about and selecting an alternate airport, one or more recommendations can be provided for selection by the autonomous flight control system.

Aspects of the subject disclosure may involve determining a suitability score to quantify the desirability, appropriateness, or suitability of each candidate alternate airport based on a comprehensive evaluation of multiple factors. In accordance with one aspect, an optimization model, machine learning model, or both can determine a suitability score based on factor scores and weights. For example, a suitability score can thus be equal to a weighted sum of factors (e.g., (0.3*fuel score)+(0.2*weather score)+(0.15*medical score)).

The following numbered clauses illustrate one or more aspects of the devices and techniques described in this disclosure.

Clause 1: A method for managing aircraft diversion, comprising: obtaining a request to divert an aircraft in flight away from an original destination airport; obtaining real-time aircraft state data from an onboard computing device through an aircraft data gateway that connects the aircraft to at least one ground-based cloud service executed on cloud computing resources; invoking at least one model configured as one of the at least one ground-based cloud service to identify one or more candidate airports and associated suitability scores from a plurality of alternate airports based on the real-time aircraft state data and information regarding the plurality of alternate airports from multiple data sources; and transmitting the one or more candidate airports, as one or more recommendations for aircraft diversion, to an avionics system for presentation to a pilot, wherein two or more of the candidate airports are ordered from most suitable to least suitable based on the associated suitability score.

Clause 2: The method of Clause 1, wherein invoking the at least one model comprises invoking a multifactor optimization model.

Clause 3: The method of Clauses 1-2, wherein invoking the at least one model comprises invoking one or more machine learning models.

Clause 4: The method of Clauses 1-3, wherein invoking the one or more machine learning models comprises invoking a machine learning model trained to identify one or more of the plurality of alternate airports reachable by the aircraft based on a predicted distance the aircraft can travel based on the real-time aircraft state data.

Clause 5: The method of Clauses 1-4, wherein invoking the one or more machine learning models comprises invoking a machine learning model trained to predict at least one of weather, wind, or visibility at the plurality of alternative airports and identify one or more of the plurality of alternate airports based on one or more of predicted weather, wind or visibility.

Clause 6: The method of Clauses 1-5, wherein invoking the one or more machine learning models comprises invoking a machine learning model trained to predict traffic at the plurality of alternate airports and identify one or more of the plurality of alternate airports based on the traffic.

Clause 7: The method of Clauses 1-6, wherein invoking the model comprises invoking an optimization model and at least one machine learning model.

Clause 8: The method of Clauses 1-7, wherein the model identifies the one or more candidate airports from the plurality of alternate airports based on a cause of the aircraft diversion communicated with the request.

Clause 9: The method of Clauses 1-8, further comprising: generating a visualization identifying the one or more candidate airports; and transmitting the visualization of the one or more candidate airports to the onboard avionics system.

Clause 10: The method of Clauses 1-9, wherein the aircraft comprises an electronic vertical takeoff and landing (eVTOL) aircraft and the airport comprises a vertiport.

Clause 11: The method of Clauses 1-10, further comprising: receiving a selected airport from the one or more candidate airports; requesting clearance to land at the selected airport; and notifying a pilot of the landing clearance.

Clause 12: The method of claim 1-11, wherein the at least one model is configured to identify one or more candidate airports based on news reports regarding one or more of the plurality of alternate airports.

Clause 13: A processing system, comprising: a memory comprising computer-executable instructions; and a processor configured to execute the computer-executable instructions and cause the processing system to perform a method in accordance with any one of Clauses 1-12.

Clause 13: A processing system, comprising means for performing a method in accordance with any one of Clauses 1-12.

Clause 14: A non-transitory computer-readable medium storing program code for causing a processing system to perform the steps of any one of Clauses 1-12.

Clause 15: A computer program product embodied on a computer-readable storage medium comprising code for performing a method in accordance with any one of Clauses 1-13.

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As described herein, the functional blocks, flowchart elements, or both may be translated into machine-readable instructions. As non-limiting examples, the machine-readable instructions may be written using any programming protocol, such as: descriptive text to be parsed (e.g., such as hypertext markup language, extensible markup language,), (ii) assembly language, (iii) object code generated from source code by a compiler, (iv) source code written using syntax from any suitable programming language for execution by an interpreter, (v) source code for compilation and execution by a just-in-time compiler. Alternatively, the machine-readable instructions may be written in a hardware description language (HDL), such as logic implemented by way of either a field programmable gate array (FPGA) configuration or an application-specific integrated circuit (ASIC) or their equivalents. Accordingly, the functionality described herein may be implemented in any conventional computer programming language, as pre-programmed hardware elements, or as a combination of hardware and software components.

As used herein, the term “determining” encompasses a wide variety of actions. For example, “determining” may include calculating, computing, processing, deriving, investigating, looking up (e.g., looking up in a table, a database, or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for managing aircraft diversion, comprising:
obtaining a request to divert an aircraft in flight away from an original destination airport;
obtaining real-time aircraft state data from an onboard computing device through an aircraft data gateway that connects the aircraft to at least one ground-based cloud service executed on cloud computing resources;
invoking at least one model configured as one of the at least one ground-based cloud service to identify one or more candidate airports and associated suitability scores from a plurality of alternate airports based on the real-time aircraft state data and information regarding the plurality of alternate airports from multiple data sources; and
transmitting the one or more candidate airports, as one or more recommendations for aircraft diversion, to an avionics system of the aircraft for presentation to a pilot, wherein two or more candidate airports are ordered from most suitable to least suitable based on the suitability scores.

2. The method of claim 1, wherein invoking the at least one model comprises invoking a multifactor optimization model.

3. The method of claim 1, wherein invoking the at least one model comprises invoking one or more machine learning models.

4. The method of claim 3, wherein invoking the one or more machine learning models comprises invoking a machine learning model trained to identify one or more of the plurality of alternate airports reachable by the aircraft based on a predicted distance the aircraft can travel based on the real-time aircraft state data.

5. The method of claim 3, wherein invoking the one or more machine learning models comprises invoking a machine learning model trained to predict at least one of weather, wind, visibility, or runway conditions at the plurality of alternative airports and identify one or more of the plurality of alternate airports based on one or more of predicted weather, wind or visibility.

6. The method of claim 3, wherein invoking the one or more machine learning models comprises invoking a machine learning model trained to predict traffic at the plurality of alternate airports and identify one or more of the plurality of alternate airports based on the traffic.

7. The method of claim 1, wherein the model identifies the one or more candidate airports from the plurality of alternate airports based on a cause of the aircraft diversion communicated with the request.

8. The method of claim 7, wherein the model identifies the one or more candidate airports from the plurality of alternate airports based further on availability of a service.

9. The method of claim 1, further comprising:
generating a visualization identifying the one or more candidate airports; and
transmitting the visualization of the one or more candidate airports to the avionics system.

10. The method of claim 1, wherein the aircraft comprises an electronic vertical takeoff and landing (eVTOL) aircraft and the airport comprises a vertiport.

11. The method of claim 1, further comprising:
receiving a selected airport from the one or more candidate airports;
requesting clearance to land at the selected airport; and
notifying a pilot of landing clearance.

12. The method of claim 1, wherein the at least one model is configured to identify one or more candidate airports based on news reports regarding one or more of the plurality of alternate airports.

13. An aircraft diversion system, the system comprising
at least one processor implemented in circuitry; and
at least one memory couple the at least one processor that stores instructions that, when executed by the at least one processor, cause the system to:
obtain a request to divert an aircraft in flight away from an original destination airport;
obtain real-time aircraft state data from an onboard computing device through an aircraft data gateway that connects the aircraft to at least one ground-based cloud service executed on cloud computing resources;
invoke at least one model configured as one of the at least one ground-based cloud service to identify one or more candidate airports and associated suitability scores from a plurality of alternate airports based on the real-time aircraft state data and information regarding the plurality of alternate airports from multiple data sources; and
transmitting the one or more candidate airports, as one or more recommendations for aircraft diversion, to an avionics system of the aircraft for presentation to a pilot, wherein two or more of the candidate airports are ordered from most suitable to least suitable based on the associated suitability scores.

14. The system of claim 13, wherein to invoke the at least one model, the instructions further cause the system to invoke one or more machine learning models.

15. The system of claim 14, wherein one of the one or more machine learning models is trained to identify one or more of the plurality of alternate airports reachable by the aircraft based on a predicted distance the aircraft can travel based on the real-time aircraft state data.

16. The system of claim 14, wherein one or the one or more machine learning models is trained to predict at least one of weather, wind, or visibility at the plurality of alternative airports and identify one or more of the plurality of alternate airports based on one or more of predicted weather, wind, or visibility.

17. The system of claim 14, wherein one of the one or more machine learning models is trained to predict traffic at the plurality of alternate airports and identify one or more of the plurality of alternate airports based on the traffic.

18. The system of claim 13, wherein the at least one model identifies the one or more candidate airports from the plurality of alternate airports based on a cause of the aircraft diversion communicated with the request.

19. The system of claim 13, wherein to invoke the at least one model, the instructions further cause the system to invoke an optimization model and at least one machine learning model.

20. A computer-readable storage medium having instructions stored thereon that, when executed, cause one or more processors to:
obtain a request to divert an aircraft in flight away from an original destination airport;
obtain real-time aircraft state data from an onboard computing device through an aircraft data gateway that connects the aircraft to at least one ground-based cloud service executed on cloud computing resources;
invoke at least one model configured as one of the at least one ground-based cloud service to identify one or more candidate airports and associated suitability scores from a plurality of alternate airports based on the real-time aircraft state data and information regarding the plurality of alternate airports from multiple data sources; and
transmitting the one or more candidate airports, as one or more recommendations for aircraft diversion, to an avionics system of the aircraft for presentation to a pilot, wherein two or more of the candidate airports are ordered from most suitable to least suitable based on the associated suitability scores.
